(19) United States
(12) Patent Application Publication
(10) Pub. No.: US 2002/0040088 A1
(43) Pub. Date: Apr. 4, 2002

(54) Cationic polymer dispersions for paper sizing

(76) Inventors: Bernd Hauschel, Leverkusen (DE); Vera Buchholz, Koln (DE); Bernd Thiele, Odenthal (DE); Johan Kijlstra, Bergisch Gladbach (DE)

Correspondence Address: BAYER CORPORATION, PATENT DEPARTMENT, 100 BAYER ROAD, PITTSBURGH, PA, 15205, US

(21) Appl. No.: 09/929,799

(22) Filed: Aug. 14, 2001

(30) Foreign Application Priority Data
Aug. 16, 2000 (DE) 10039747.6
Sep. 21, 2000 (DE) 10046770.9

(51) Int. Cl. C08L 11/02

(52) U.S. Cl. 524/460; 524/458

(57) ABSTRACT

The present invention relates to cationic aqueous polymer dispersions comprising small particles, the cationic aqueous polymer dispersions are used for internal sizing and surface sizing of paper, board and cardboard.

### BACKGROUND OF THE INVENTION

The present invention relates to cationic aqueous polymer dispersions comprising small particles that are used for internal sizing and surface sizing of paper, board and cardboard.

Polymer dispersions that have cationic charges are preferably used for the internal sizing and surface sizing of paper, board and cardboard, since, owing to their affinity to cellulose fibers, cationic charges particularly readily become attached to them.

In principle, two types of aqueous dispersions that have cationic groups and can be used for sizing paper are known. One comprises polymer dispersions that have cationic groups and the other amphoteric polymer dispersions that also have anionic groups in addition to the cationic groups.

DE 24 54 397 A discloses cationic aqueous copolymer dispersions prepared by emulsion copolymerization of olefinically unsaturated monomers in the presence of cationic polymeric dispersants. The preparation of the cationic dispersant is effected by solution polymerization of, inter alia, monomers that have quaternary or tertiary nitrogen groups, water-miscible organic solvents preferably being employed, particularly low molecular weight alcohols or acetone being used. When cationic monomers having a tertiary nitrogen atom are used, formic acid is added in addition to the solvents mentioned, in order to introduce the cationic charge. The disadvantage of these dispersions is their high content of readily volatile organic solvents. Owing to their presence, problems relating to occupational hygiene are encountered on drying the paper, that is carried out at temperatures of about 60-80° C. Readily volatile organic solvents must therefore be removed from the end product by a distillation step, making the preparation process for these products more expensive.

EP 051 144 A states that the cationic aqueous copolymer dispersions disclosed in DE 24 54 397 A are still in need of improvement in their effectiveness as sizing agents. An improvement was achieved by incorporation of an ethylenically unsaturated carboxylic acid or of maleic anhydride as polymerized units, with the result that amphoteric aqueous polymer dispersions were obtained. It is stated that films of dried, amphoteric dispersions are substantially more water-resistant than films of cationic dispersions having a similar composition, as described, for example, in DE 24 54 397 A. However, the presence of a carboxylic acid as polymerized units leads to a greater tendency of the prepared polymer dispersion to foam during the surface sizing of paper.

There was therefore a need for improved polymer dispersions that have a low content of readily volatile organic solvents, exhibit little tendency to foam and have good sizing properties.

Surprisingly, cationic aqueous polymer dispersions that have greater effectiveness than the amphoteric polymer dispersions described in the prior art and contain no readily volatile organic solvents or only small amounts thereof have now been found.

### SUMMARY OF THE INVENTION

The invention relates to a cationic aqueous polymer dispersion comprising small particles

comprising an emulsion polymerization product of: (1) a monomer mixture comprising a) from about 20 to about 60% by weight of at least one optionally substituted styrene, b) from about 40 to about 80% by weight of at least one C₁-C₁₈-(meth)acrylic acid ester and c) from 0 to about 20% by weight of at least one non-ionic ethylenically unsaturated monomer differing from a) and b), the sum of a)+b)+c) being 100% by weight, wherein the monomer mixture is polymerized in the presence of (2) an emulsifier comprising a solution polymerization product of a monomer mixture comprising d) from about 15 to about 35% by weight of at least one

(meth)acrylic acid ester and/or (meth)acrylamide which contains a tertiary amino group, e) from about 65 to about 85% by weight of at least one optionally substituted styrene and f) from 0 to about 20% by weight of at least one non-ionic or cationic ethylenically unsaturated monomer differing from d) and e), the sum of d)+e)+f) being 100% by weight, wherein the solution polymerization is carried out in a saturated C₁-C₆-carboxylic acid. The invention is also directed to a process for making a cationic aqueous polymer dispersion. These and other features, aspects, and advantages of the present invention will become better understood with reference to the following description and appended claims.

### DESCRIPTION OF THE INVENTION

The invention relates to a cationic aqueous polymer dispersion comprising small particles

comprising an emulsion polymerization product of: (1) a monomer mixture comprising a) from about 20 to about 60% by weight of at least one optionally substituted styrene, b) from about 40 to about 80% by weight of at least one C₁-C₁₈-(meth)acrylic acid ester and c) from 0 to about 20% by weight of at least one non-ionic ethylenically unsaturated monomer differing from a) and b), the sum of a)+b)+c) being 100% by weight, wherein the monomer mixture is polymerized in the presence of (2) an emulsifier comprising a solution polymerization product of a monomer mixture comprising d) from about 15 to about 35% by weight of at least one

(meth)acrylic acid ester and/or (meth)acrylamide which contains a tertiary amino group, e) from about 65 to about 85% by weight of at least one optionally substituted styrene and f) from 0 to about 20% by weight of at least one non-ionic or cationic ethylenically unsaturated monomer differing from d) and e), the sum of d)+e)+f) being 100% by weight, wherein the solution polymerization is carried out in a saturated C₁-C₆-carboxylic acid.

The preparation of the polymer dispersion according to the invention is carried out by emulsion polymerization of a monomer mixture a)−c) in the presence of an aqueous polymer dispersion that acts as an emulsifier. The emulsifier is in turn obtained by solution polymerization of the monomer mixture d)−f) in a saturated C₁-C₆-carboxylic acid and is optionally mixed with water after intermediate isolation and/or working up.

For the preparation of the emulsifier, (meth)acrylic acid esters or (meth)acrylamides of the formula (I)

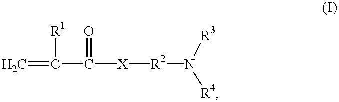

in which

R¹ represents H or methyl,

R² represents a linear C₁-C₄-alkylene radical,

R³ and R⁴ are identical or different and represent C₁-C₄-alkyl and

x represents O or NH, are preferably used as monomers of the group d).

In particular, compounds that correspond to the formula (I), in which R³ and R⁴ are identical and represent methyl or ethyl, are used as monomers of the group d). Particularly preferably, compounds of the formula (I) in which X represents NH and R³ and R⁴ are identical and represent methyl or ethyl, are used as monomers of the group d). Those monomers of the group d) that correspond to the formula (I), in which R¹ represents H or methyl, R² represents n-propyl, R³ and R⁴ are identical and represent methyl and X represents NH, are very particularly preferably used.

For the preparation of the emulsifier, at least one styrene that may be optionally substituted is used as a monomer of the group e). From the series of the substituted styrenes, α-methylstyrene or vinyltoluene is preferably used. Unsubstituted styrene is particularly preferably used.

For the preparation of the emulsifier, non-ionic or cationic ethylenically unsaturated monomers differing from d) and e) are used as monomers of the group f). Nitriles such as acrylonitrile or methacrylonitrile are preferably used. The following are also preferred: amides e.g., acrylamide, methacrylamide or N-methylolacrylamide, vinyl compounds such as vinyl acetate or vinyl propionate, acrylic acid or methacrylic acid esters of alcohols having 1-18 C atoms, e.g., methyl acrylate, methyl methacrylate, ethyl acrylate, ethyl methacrylate, propyl acrylate, propyl methacrylate, n-, iso- and tert-butyl acrylate, n-, iso- and tert-butyl methacrylate, hexyl acrylate, hexyl methacrylate, ethylhexyl acrylate, stearyl acrylate and stearyl methacrylate, or esters of acrylic acid or methacrylic acid that were prepared by reaction with at least one ethylene oxide unit, e.g., hydroxyethyl methacrylate or diethylene glycol monomethacrylate, vinylpyridine or the quaternized ammonium salts that are derived from the formula (I) and can be obtained, for example, by reacting compounds according to the formula (I) with conventional quaternizing reagents such as methyl chloride, benzyl chloride, dimethyl sulfate or epichlorohydrin. Particularly preferred cationic monomers of the group f) include 2-(acryloyloxy) ethyltrimethylammonium chloride, 2-(methacryloyloxy) ethyltrimethylammonium chloride, 3-(acrylamido) propyltrimethylammonium chloride or 3-(methacrylamido)propyltrimethyl-ammonium chloride.

The parts by weight of the monomers mentioned under d)−f) relate to the total amount of the monomers used for the preparation of the emulsifier, the sum of d)+e)+f) being 100% by weight. Preferably, from about 20 to about 30% by weight of d), from about 70 to about 80% by weight of e) and from 0 to about 10% by weight of f) are used.

The solution polymerization carried out for the preparation of the emulsifier is carried out as a free radical polymerization in a saturated C₁-C₆ -carboxylic acid as solvent. Both saturated C₁-C₆-monocarboxylic acids and saturated C₁-C₆-dicarboxylic acids may be used, saturated C₁-C₆-monocarboxylic acids preferably being used. The saturated C₁-C₆-carboxylic acids used optionally carry further substituents such as hydroxyl groups. The solution polymerization is preferably carried out in formic acid, acetic acid, propionic acid, butyric acid, isobutyric acid, valeric acid, isovaleric acid, caproic acid, hydroxypropionic acid or hydroxybutyric acid. Mixtures of different saturated C₁-C₆-carboxylic acids may also be used. The solution polymerization is preferably carried out in formic acid, acetic acid, propionic acid or hydroxypropionic acid, particularly preferably in acetic acid. The saturated C₁-C₆-carboxylic acid used preferably contains not more than about 20% by weight of water, particularly preferably not more than about 10% by weight of water, very particularly preferably not more than about 1% by weight of water, based on the total amount of solvent. Very particularly preferably, the solution polymerization is carried out in at least about 99% acetic acid without admixture of other carboxylic acids. The amount of solvent is chosen so that the concentration of the resulting emulsifier solution is from about 20 to about 70% by weight, calculated from the amount of monomers used.

The solution polymerization is preferably carried out in the presence of a chain transfer agent. Suitable chain transfer agents are in particular sulfur compounds, e.g., thioglycolic acid or mercaptans such, as ethyl mercaptan, n-butyl mercaptan, tert-butyl mercaptan, n-dodecyl mercaptan or tert-dodecyl mercaptan. Mercaptans are preferably used, particularly preferably C₈-C₁₄-alkyl mercaptans.

The solution polymerization is initiated by a free radical initiator. Peroxo or azo compounds such as hydrogen peroxide, sodium peroxo-disulfate, potassium peroxodisulfate and ammonium peroxodisulfate, di-tert-butyl peroxide, dibenzoyl peroxide, azobisisobutyronitrile, 2,2′-azobis (2-methylbutyronitrile), 2,2′-azobis(2,4-dimethylvaleronitrile) or 2,2′-azobis (2-amidinopropane) dihydrochloride, are preferably used as free radical initiators for the solution polymerization. Azo compounds are preferably used, particularly preferably nitriles such as azobisisobutyroni-trile, 2,2′-azobis(2-methylbutyronitrile) or 2,2′-azobis(2,4-dimethylvalero-nitrile).

The amount of free radical initiator and chain transfer agent when carrying out the solution polymerization is chosen so that an emulsifier having a weight average molecular weight of from about 5,000 to 100,000 g/mol is obtained. The determination of the molecular weight distribution and of the weight average molecular weight can be carried out by methods known to a person skilled in the art, e.g., gel permeation chromatography, light scattering or ultracentrifuging.

The polymerization temperature for the solution polymerization is prefer from about 30 to about 105° C., particularly preferably from about 70 to about 100° C. The temperature may also be higher if the procedure is carried out under superatmospheric pressure in a pressure-resistant reactor. The solution polymerization is preferably carried out in an inert gas atmosphere such as in a nitrogen atmosphere. Thorough mixing of the reaction batch is advantageous, and suitable stirrers may be used for this purpose. The duration of the polymerization is usually 1-10 hours.

When carrying out the solution polymerization for the preparation of the emulsifier, the saturated C₁-C₆-carboxylic acid is initially introduced completely or partially into the reaction vessel in a preferred embodiment. Monomers, free radical initiators and optionally chain transfer agents are preferably initially introduced completely or partially in the C₁-C₆-carboxylic acid or, in another preferred embodiment, are metered in continuously or in a staggered manner into the reaction batch.

In a further preferred embodiment of the solution polymerization, the monomers and optionally the chain transfer agent are initially introduced in the C₁-C₆-carboxylic acid, and the free radical initiator is metered into the reaction mixture over a specific period. The addition of the free radical initiator can be effected either uniformly or nonuniformly over the metering period.

In a further preferred embodiment of the solution polymerization, the acetic acid and optionally the chain transfer agent are initially introduced while the monomers and the free radical initiator are added continuously to the reaction mixture. All metering operations may be effected either uniformly or non-uniformly over the metering period. When a chain transfer agent is used, it is either completely initially introduced or added continuously to the reaction mixture during the polymerization.

In all above-mentioned embodiments, the free radical initiator is added to the reaction batch either in solid, liquid or dissolved form. If the free radical initiator is a solid, the use of a solution of this free radical initiator is preferred. Preferred used solvents are low molecular weight alcohols, e.g., isopropanol, low molecular weight ketones such as acetone, or the saturated C₁-C₆-carboxylic acid used as a solvent.

If a solvent differing from the C₁-C₆-carboxylic acid employed is used for dissolving a free radical initiator present as a solid, amounts such that only a very low content of less than about 1% of readily volatile solvent is present in the end product are as a rule sufficient. A saturated C₁-C₆-Carboxylic acid, particularly preferably acetic acid, is particularly preferably used for dissolving the free radical initiator that is present as a solid, since the end product is thus completely free of readily volatile organic solvents.

After the end of the solution polymerization, the emulsifier obtained is either isolated or is mixed directly with water. The emulsifier obtained is preferably mixed directly with water said mixing results in an aqueous polymer dispersion. The aqueous polymer dispersion contains from about 2-20% soldis by weight, particularly preferably from about 5 to about 15% by weight of the solution polymerization product of a monomer mixture comprising monomers d)−f). The aqueous polymer dispersion can be used directly as an initially introduced mixture for carrying out the emulsion polymerization for the preparation of the cationic aqueous polymer dispersion according to the invention.

The two-stage process can thus be carried out very simply in a one-pot process without the emulsifier having to be isolated or worked up.

The cationic aqueous polymer dispersion according to the invention is prepared by emulsion polymerization of a monomer mixture containing a)−c), the aqueous polymer dispersion prepared in the first stage serving as an emulsifier.

For the preparation of the cationic aqueous polymer dispersion according to the invention, styrene and/or substituted styrenes such as (x-methylstyrene or vinyltoluene, are used as monomers of group a). Unsubstituted styrene is particularly preferably used.

For the preparation of the cationic aqueous polymer dispersion according to the invention, at least one C₁ -C₁ 8-(meth)acrylic acid ester is used as monomer of the group b). Methyl acrylate, methyl methacrylate, ethyl acrylate, ethyl methacrylate, propyl acrylate, propyl methacrylate, n-, iso- and tert-butyl acrylate, n-, iso- and tert-butyl methacrylate, hexyl acrylate, hexyl methacrylate, ethylhexyl acrylate, stearyl acrylate and stearyl methacrylate are preferably used. n-Butyl acrylate or binary mixtures that contain between 10 and 90% by weight of n-butyl acrylate are particularly preferably used. Mixtures of n-butyl acrylate and tert-butyl acrylate are very particularly preferably used.

For the preparation of the cationic aqueous polymer dispersion according to the invention, at least one non-ionic, ethylenically unsaturated monomer differing from a) and b) is used as monomer of the group c). Nitriles such as acrylonitrile or methacrylonitrile, amides such as acrylamide, methacrylamide or n-methylolacrylamide, vinyl compounds such as vinyl acetate or vinyl propionate, dienes such as butadiene or isoprene, and esters of acrylic acid or methacrylic acid and at least one ethylene oxide unit such as hydroxyethyl methacrylate or diethylene glycol monomethacrylate, are preferably used.

The parts by weight of the monomers mentioned under a)−c) relate to the total amount of the monomers used for the preparation of the second stage, the sum of a)+b)+c) being 100% by weight. Preferably, from about 30 to about 50% by weight of a) and from about 50 to about 70% by weight of b) and from 0 to about 10% by weight of c) are preferably used.

For the preparation of the cationic aqueous polymer dispersion according to the invention, the monomers a)−c) are preferably metered continuously into the reaction batch, either as a mixture or separately from one another, when carrying out the emulsion polymerization. The addition may be effected uniformly or non-uniformly over the metering period, i.e., at a varying metering rate.

A free radical initiator is used for initiating the emulsion polymerization. Preferably used free radical initiators are peroxo or azo compounds such as potassium peroxodisulfate, sodium peroxodisulfate or ammonium peroxodisulfate, hydrogen peroxide, tert-butyl hydroperoxide, di-tert-butyl peroxide, dibenzoyl peroxide, azobisisobutyronitrile or 2,2′-azobis (2-methylbutyronitrile). Preferably used free radical initiators are water-soluble free radical initiators, particularly preferably hydrogen peroxide. The preferred water-soluble free radical initiators are preferably combined with reducing agents such as sodium sulfite, sodium pyrosulfite, sodium bisulfite, sodium dithionite, sodium hydroxymethanesulfinate or ascorbic acid. Furthermore, the preferred water-soluble free radical initiators are preferably combined with heavy metal salts such as cerium, manganese or iron(II) salts, to give a redox system. Particularly preferably, hydrogen peroxide is used in combination with a reducing agent and/or with a heavy metal salt. In a further preferred embodiment, ternary initiator systems containing water-soluble free radical initiator, reducing agent and heavy metal salt are used, the ternary initiator system comprising hydrogen peroxide, iron(II) sulfate and ascorbic acid being preferred.

Preferably, some of the free radical initiator is initially introduced before the beginning of the monomer feed, and the remainder is added continuously during the polymerization. In a further preferred embodiment, the total amount of the free radical initiator is added continuously, the metering of the free radical initiator and the metering of the monomers preferably beginning simultaneously.

If, in a preferred embodiment of the emulsion polymerization, a water-soluble free radical initiator is combined with a reducing agent, the reducing agent is preferably initially introduced before the beginning of the emulsion polymerization.

If a water-soluble free radical initiator is used in combination with a heavy metal salt for initiating the emulsion polymerization, a complexing agent for complexing the heavy metal salt used is preferably added after the end of the polymerization. Preferred complexing agents are, for example, ethylenediaminetetraacetic acid, nitrilotriacetic acid, diethylene-triaminepentaacetic acid, polyaspartic acid, iminodisuccinic acid or the corresponding salts of the above-mentioned acids. The amount of complexing agent used depends on the amount of heavy metal salt used and is preferably from 1 to 10 mol per mol of heavy metal ion.

In a preferred embodiment, for the preparation of the cationic aqueous polymer dispersion according to the invention, an oil-soluble free radical initiator sparingly soluble in water and intended for subsequent activation is added after the end of the emulsion polymerization for reducing the residual monomer content. Such free radical initiators are compounds that preferably have a water solubility of<1% at room temperature. Organic peroxides such as dibenzoyl peroxide, di-tert-butyl peroxide, tert-butyl hydroperoxide, cumyl hydroperoxide or bis-cyclohexyl peroxodicarbonate, are preferably used. By subsequent activation with an oil-soluble free radical initiator sparingly soluble in water, the contents of all residual monomers can be reduced below 100 ppm.

The pH of the emulsion polymerization batch is preferably from about 2 to about 5. The pH can be adjusted before the emulsion polymerization is carried out, by adding acids, bases or buffers. The emulsion polymerization is preferably carried out without further additions of acids, bases or buffers. Before or during the emulsion polymerization, customary low molecular weight non-ionic, anionic or cationic emulsifiers may be added for increasing the dispersing effect. Examples of these are sodium alkanesulfonates, sodium alkylsulfates, sodium dodecylbenzene-sulfonates, sulfosuccinic acid esters, fatty alcohol ethoxylates, alkylaryl ethoxylates, primary, secondary and tertiary fatty amine salts, quaternary alkylammonium salts, alkylbenzylammonium salts, quaternary amidoamine compounds, alkylpyridinium salts, alkylimidazolinium salts or alkyloxazolinium salts. The emulsion polymerization is preferably carried out without addition of low molecular weight emulsifiers.

The polymerization temperature for the emulsion polymerization is preferably from about 30 to about 100° C., particularly preferably from about 70 to about 100° C. The temperature may also be higher if a pressure-resistant reactor under superatmospheric pressure is employed. The emulsion polymerization is preferably carried out in an inert gas atmosphere such as in a nitrogen atmosphere. Thorough mixing of the reaction batch is advantageous, and suitable stirrers can be used for this purpose. The duration of the polymerization is usually from about 0.5 to about 10 hours.

The concentration of the cationic aqueous polymer dispersion according to the invention is preferably from about 10 to about 40% by weight, particularly preferably from about 15 to about 35% by weight. The viscosity of a 20% solids dispersion is as a rule from about 3 to about 30 mPas, measured at a temperature of 23° C. The mean particle size of a 20% solids dispersion is preferably less than about 100 nm, particularly preferably from about 5 to about 50 nm. The mean particle size can be determined by methods known to a person skilled in the art such as laser correlation spectroscopy, ultracentrifuging or turbidity measurement.

In order to increase the stability of the cationic aqueous polymer dispersion according to the invention to fungal and/or bacterial attack, a biocide is preferably added. Biocides based on isothiazolinones, benzisothiazolinones or biocides based on benzyl alcohol/formaldehyde condensates that release formaldehyde after addition to the aqueous dispersion are preferably used.

The dispersions according to the invention are cationic sizing agents that are completely or substantially free of organic solvents and have high effectiveness and little tendency to foam. They can be used for the internal sizing and surface sizing of paper, board and cardboard. The dispersions according to the invention are preferably suitable for the sizing of alum-containing or alum-free papers produced under acidic or neutral conditions and filled with clay, natural or precipitated calcium carbonate, talc, titanium dioxide or other fillers. Suitable fibers are bleached or unbleached, wood-free or wood-containing, wastepaper-containing or deinked pulps. The dispersions according to the invention are particularly suitable for the internal sizing and surface sizing of papers, boards and cardboards comprising wood-containing and wastepaper-containing stocks such as corrugated boards and cardboard for packaging purposes, newsprint, or wood-containing printing papers. Often, for example, packaging papers produced from wastepaper are coloured with basic or cationic dyes, with which the dispersions according to the invention are outstandingly compatible, whereas this is not the case with amphoteric or anionic dispersions.

In a preferred embodiment, the dispersions according to the invention are used as internal sizing agents since, owing to their cationic charges, they have an affinity to the cellulose fibers and, when added to the paper stock become attached to said fibers. The dispersions according to the invention are preferably added in the wet end of the paper machine, i.e. before the sheet formation with the paper stock, optionally in combination with other internal sizing agents. The amount of sizing agent (calculated as polymer solid) is preferably from about 0.1 to about 3% by weight, based on the dry paper stock, in the case of internal sizing. The advantage over the widely used internal sizing agents comprising alkylketene dimer (AKD) or alkenylsuccinic anhydride (ASA) is the development of the full sizing effect immediately after the dryer section of the paper machine, whereas a subsequent maturing time is usually required for the development of the full sizing effect in the case of AKD and ASA. Furthermore, the desired degree of sizing can be exactly established through the choice of the added amount, which is very difficult, for example, when AKD is used.

In a further preferred embodiment, the dispersions according to the invention are used as surface sizing agents. The base papers may be either unsized or presized with customary internal sizing agents such as rosin size, AKD or ASA. The application is effected with the aid of customary application units such as a size press, film press, speed sizer or gate roll. If the dispersions according to the invention are used as surface sizing agents, preferably from about 0.1 to about 10% by weight are added to the size liquor. The exact amount depends on the presizing of the base paper and on the desired sizing effect. Preferably, the dispersions according to the invention are used as surface sizing agents together with from 0 to about 20% by weight of starch in the size liquor. The dispersions according to the invention are very compatible with customary size press starches such as enzymatically or oxidatively degraded or derivatized starches, particularly cationic starches. If the dispersions according to the invention are used as surface sizing agents, they are outstandingly suitable for use together with dyes, preferably basic or cationic dyes. Furthermore, the dispersions according to the invention are outstandingly suitable for use together with inorganic white pigments. These can be added to the size liquor for improving the printability. Examples of these are natural or precipitated calcium carbonate, clay, barium sulfate, titanium dioxide, talc or annaline.

The high stability of the dispersions according to the invention to electrolytes such as sodium chloride, calcium carbonate, magnesium carbonate or aluminium sulfate, is particularly advantageous. The cations and anions from these electrolytes are often contained in size liquors, either as a result of migration from the paper web, as a result of deliberate addition or as a result of introduction with the fresh water used in the paper mill.

The dispersions according to the invention impart to the sized papers very good properties with respect to all modern printing processes, particularly when used in the surface. Thus, in the case of inkjet printing, high ink density and brilliance, little strike-through, very crisp edges and little bleeding in combination with smudge resistance and water resistance are required. By surface application of the dispersions according to the invention, these requirements are met very well. With the use of toners, that is to say, for example, in customary copiers and laser printers, high toner adhesion to the printed paper is required. This property, too, is fulfilled in an outstanding manner by surface application of the dispersions according to the invention to, for example, papers pre-sized with AKD by internal sizing. Furthermore, the dispersions according to the invention are suitable, on surface application, for reducing dusting and picking, which is advantageous for all customary printing processes.

The invention is further described in the following illustrative examples in which all parts and percentages are by weight unless otherwise indicated.

### EXAMPLES

### Preparation Examples.

### Example 1

Preparation of the Emulsifier

A mixture of 630.75 g of styrene, 239.25 g of N,N-dimethylamino-propylmethacrylamide, 4.5 g of tert-dodecyl mercaptan (95%) and 705 g of glacial acetic acid was initially introduced at room temperature into a 2 l flask having a plane-ground joint and a stirrer and jacket heating and was heated to 95° C. under a nitrogen atmosphere and with stirring. After the reaction temperature had been reached, a solution of 12.0 g of azobisisobutyronitrile in 80.0 g of acetone was metered uniformly into the reaction solution over a period of 120 min with continuing stirring. The batch was then stirred for a further 120 min at 95° C. and then cooled. A part of the batch was discharged, and 279.2 g remained in the apparatus for the preparation of the 2n^{d} stage. A clear polymer solution having a viscosity of 37 200 mPa.s was obtained.

Preparation of the Cationic Polymer Dispersion 1 260 g of demineralized water were added at room temperature, while stirring, to the 279.2 g of the emulsifier remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 20.0 g of a 1% iron(II) sulfate solution were added. Thereafter, a mixture of 129.5 g of styrene and 92.5 g of n-butyl acrylate, and 64.8 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 2.0 g of tert-butyl hydroperoxide (80%) were added for subsequent activation. After stirring had been carried out for a further 60 min at 85° C., the batch was cooled and 0.9 g of Preventol® D2 and 10.0 g of a 10% aqueous Trilon® B solution were added at room temperature.

A polymer dispersion having a solids content of 19.7% was obtained. A 2.5% solids dispersion was prepared by dilution with demineralized water had an extinction of 1.02 at 660 nm.

### Example 2

Preparation of the Emulsifier A mixture of 319.3 g of styrene, 115.7 g of N,N-dimethylamino-propylmethacrylamide, 5.2 g of tert-dodecyl mercaptan (95%) and 350 g of glacial acetic acid was initially introduced at room temperature into a 2 l flask having a plane-ground joint and a stirrer and jacket heating and was heated to 95° C. under a nitrogen atmosphere and with stirring. After the reaction temperature had been reached, a solution of 4.3 g of 2,2″azobis(2-methylbutyronitrile) in 40.0 g of acetone was metered uniformly into the reaction solution over a period of 120 min with continuing stirring. The batch was then stirred for a further 120 min at 95° C. and then cooled. A part of the batch was discharged, and 280.5 g remained in the apparatus for the preparation of the 2ⁿd stage. A clear polymer solution having a viscosity of 12 300 mPa.s was obtained.

Preparation of the Cationic Polymer Dispersion

1,228 g of demineralized water were added at room temperature, while stirring, to the 280.5 g of the emulsifier remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 4.0 g of a 1% iron(II) sulfate solution were added. Thereafter, a mixture of 88.8 g of styrene, 74.0 g of n-butyl acrylate and 61.05 g of tert-butyl acrylate, and 65.3 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 2.0 g of tert-butyl hydroperoxide (80%) were added for subsequent activation. After stirring had been carried out for a further 60 min at 85° C., the batch was cooled and 0.9 g of Preventol® D2 were added at room temperature.

A polymer dispersion having a solids content of 20.2% and an extinction of 0.42 (measured at 660 nm on an aqueous sample diluted to 2.5%) was obtained.

### Example 3

Preparation of the Emulsifier

A mixture of 324.0 g of styrene, 111.0 g of N,N-dimethylaminoethyl methacrylate, 0.6 g of tert-dodecyl mercaptan (95%) and 330 g of glacial acetic acid was initially introduced at room temperature into a 2 l flask having a plane-ground joint and a stirrer and jacket heating and was heated to 95° C. under a nitrogen atmosphere and with stirring. After the reaction temperature had been reached, a solution of 5.0 g of azobisisobutyronitrile in 60.0 g of acetone was metered into the reaction solution over a period of 120 min with continuing stirring. The batch was then stirred for a further 120 min at 850° C. and then cooled. A part of the batch was discharged, and 272.3 g remained in the apparatus for the preparation of the 2^{nd} stage. A clear polymer solution having a viscosity of 26 300 mPa.s was obtained.

Preparation of the Cationic Polymer Dispersion

1,253 g of demineralized water were added at room temperature, while stirring, to the 272.3 g of the emulsifier remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 20.0 g of a 1% iron(II) sulfate solution were added. Thereafter, a mixture of 112.9 g of styrene, 56.4 g of n-butyl acrylate and 56.4 g of tert-butyl acrylate, and 65.8 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 2.0 g of tert-butyl hydroperoxide (80%) were added for subsequent activation. After stirring had been carried out for a further 60 min at 85° C., the batch was cooled and 0.9 g of Preventol® D2 and 10.0 g of a 10% aqueous Trilon® B solution were added at room temperature.

A polymer dispersion having a solids content of 19.8% and an extinction of 1.05 (measured at 660 nm on an aqueous sample diluted to 2.5%) was obtained.

### Example 4

Preparation of the Emulsifier

A mixture of 324.0 g of styrene, 76.2 g of N,N-dimethylaminoethyl methacrylate, 48.3 g of 2-(acryloyloxy)ethyltrimethylammonium chloride (as an 80% strength aqueous solution) and 0.6 g of tert-dodecyl mercaptan (95%) and 330 g of glacial acetic acid was initially introduced at room temperature into a 2 l flask having a plane-ground joint and a stirrer and jacket heating and was heated to 95° C. under a nitrogen atmosphere and with stirring. After the reaction temperature had been reached, a solution of 3.0 g of azobisisobutyronitrile in 60.0 g of acetone was uniformly metered into the reaction solution over a period of 120 min with. continuing stirring. The batch was then stirred for a further 120 min at 95° C. and then cooled. A part of the batch was discharged, and 277.5 g remained in the apparatus for the preparation of the 2^{nd} stage. A clear polymer solution having a viscosity of 17 400 mPa.s was obtained.

Preparation of the Cationic Polymer Dispersion

1,249 g of demineralized water were added at room temperature, while stirring, to the 277.5 g of the emulsifier remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 20.0 g of a 1% iron(II) sulfate solution were added. Thereafter, a mixture of 112.9 g of styrene, 56.4 g of n-butyl acrylate and 56.4 g of tert-butyl acrylate, and 65.8 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 2.0 g of-tert-butyl hydroperoxide (80%) were added for subsequent activation. After stirring had been carried out for a further 60 min at 85° C., the batch was cooled and 0.9 g of Preventol® D2 and 10.0 g of a 10% aqueous Trilon® B solution were added at room temperature.

A polymer dispersion having a solids content of 19.8% and an extinction of 0.93 (measured at 660 nm on an aqueous sample diluted to 2.5%) was obtained.

### Example 5

Preparation of the Emulsifier

A mixture of 638.6 g of styrene, 231.4 g of N,N-dimethylamino-propylmethacrylamide, 10.4 g of tert-dodecyl mercaptan (95%) and 550 g of glacial acetic acid was initially introduced at room temperature into a 2 l flask having a plane-ground joint and a stirrer and jacket heating and was heated to 95° C. under a nitrogen atmosphere and with stirring. After 95° C. had been reached, a solution of 12.8 g of azobisisobutyronitrile in 230 g of glacial acetic acid was metered uniformly into the reaction solution over a period of 120 min with continuing stirring. The batch was then stirred for a further 120 min at 95° C. and then cooled. A part of the batch was discharged, and 275.8 g remained in the apparatus for the preparation of the 2n^{d} stage. A clear polymer solution having a viscosity of 73 000 mPa.s was obtained.

Preparation of the Cationic Polymer Dispersion 1,223 g of demineralized water were added at room temperature, while stirring, to the 275.8 g of the emulsifier remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 4.0 g of a 1% iron(II) sulfate solution were added. Thereafter, a mixture of 88.8 g of styrene, 67.5 g of n-butyl acrylate and 67.5 g of tert-butyl acrylate, and 78.3 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 3.0 g of tert-butyl hydroperoxide (80%) were added for subsequent activation. After stirring had been carried out for a further 60 min at 85° C., the batch was cooled and 0.9 g of Preventol® D2 were added at room temperature.

A polymer dispersion having a solids content of 19.8% and an extinction of 0.64 (measured at 660 nm on an aqueous sample diluted to 2.5%) was obtained.

### Example 6

Preparation of the Emulsifier

A mixture of 604.0 g of styrene, 266.0 g of N,N-dimethylaminoethyl methacrylate and 1.2 g of tert-dodecyl mercaptan (95%) and 660 g of glacial acetic acid was initially introduced at room temperature into a 2 l flask having a plane-ground joint and a stirrer and jacket heating and was heated to 85° C. under a nitrogen atmosphere and with stirring. After 85° C. had been reached, a solution of 10.1 g of azobisisobutyronitrile in 120 g of acetone was uniformly metered into the reaction solution over a period of 120 min with continuing stirring. The batch was then stirred for a further 120 min at 85° C. and then cooled. A part of the batch was discharged, and 272.3 g remained in the apparatus for the preparation of the 2^{nd} stage. A clear polymer solution having a viscosity of 70 000 mPa.s was obtained.

Preparation of the Cationic Polymer Dispersion

1,253 g of demineralized water were added at room temperature, while stirring, to the 272.3 g of the emulsifier remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 20.0 g of a 1% iron(lI) sulfate solution were added. Thereafter, a mixture of 112.9 g of styrene, 94.0 g of n-butyl acrylate and 18.8 g of methyl methacrylate, and 65.8 g of a 3% hydrogen peroxide solution were metered simultaneously into the reaction mixture over 90 min at a constant rate from separate feeds, the temperature of 85° C. being kept constant. After the end of the feeds, the batch was stirred for a further 15 min at 85° C. and then 2.0 g of tert-butyl hydroperoxide (80%) were added for subsequent activation. After stirring had been carried out for a further 60 min at 85° C., the batch was cooled and 0.9 g of Preventol® D2 and 10.0 g of a 10% aqueous Trilon® B solution were added.

A polymer dispersion having a solids content of 19.8% and an extinction of 0.71 (measured at 660 nm on an aqueous sample diluted to 2.5%) was obtained.

### Example 7

Preparation of the Emulsifier

A mixture of 319.3 g of styrene, 115.7 g of N,N-dimethylamino-propylmethacrylamide, 5.2 g of tert-dodecyl mercaptan (95%) and 350 g of glacial acetic acid was initially introduced at room temperature into a 2 l flask having a plane-ground joint and a stirrer and jacket heating and was heated to 95° C. under a nitrogen atmosphere and with stirring. After the reaction temperature had been reached, a solution of 6.4 g of azobisisobutyronitrile in 40.0 g of acetone was metered uniformly into the reaction solution over a period of 120 min with continuing stirring. The batch was then stirred for a further 120 min at 95° C. and then cooled. A part of the batch was discharged, and 275.8 g remained in the apparatus for the preparation of the 2^{nd} stage. A clear polymer solution having a viscosity of 15 900 mPa.s was obtained.

Preparation of the Cationic Polymer Dispersion 1,232 g of demineralized water were added at room temperature, while stirring, to the 275.8 g of the prepolymer remaining in the apparatus. The mixture was heated to 85° C. under a nitrogen atmosphere and with continuing stirring. A homogeneous, slightly turbid liquid phase was obtained. After the reaction temperature had been reached, the initially introduced mixture was stirred for a further 15 min and then 4.0 g of a 1% iron(II) sulfate solution were added. Thereafter, a mixture of 103.0 g of styrene, 60.4 g of n-butyl acrylate and 60.4 g of tert-butyl acrylate, and 78.3 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 3.0 g of tert-butyl hydroperoxide (80%) were added for subsequent activation. After stirring had been carried out for a further 60 min at 85° C., the batch was cooled and 0.9 g of Preventole D2 was added.

A polymer dispersion having a solids content of 20.0% and an extinction of 0.60 (measured at 660 nm on an aqueous sample diluted 1:10) was obtained.

### Example 8

Preparation of the Emulsifier

A mixture of 119.0 g of styrene, 43.0 g of N,N-dimethylamino-propylmethacrylamide, 90 g of glacial acetic acid and 1.5 g of azobisiso-butyronitrile was initially introduced, at room temperature, into a 2 l flask having a plane-ground joint and a stirrer and jacket heating and was heated to 85° C. under a nitrogen atmosphere and with stirring. After the reaction temperature had been reached, stirring was carried out for a further 30 min and a solution of 1.9 g of azobisisobutyronitrile in 11 g of acetone was then metered uniformly into the reaction solution over a period of 60 min. The batch was then stirred for a further 30 min at 85° C. and then 875 g of demineralized water were added. For dissolution of the polymer, stirring was carried out for a further 35 min at 65-85° C., followed by cooling.

Preparation of the Cationic Polymer Dispersion

The emulsifier from stage 1, heated to 85° C., was first stirred for 15 min and then 6 g of a 1% iron(Il) sulfate solution and 30.0 g of a 6% strength hydrogen peroxide solution were added in succession. Thereafter, a mixture of 99.0 g of styrene, 94.5 g of n-butyl acrylate and 94.5 g of tert-butyl acrylate, and 120.0 g of a 6% hydrogen peroxide solution, were metered into the reaction mixture simultaneously over 120 min at a constant rate from separate feeds, the temperature being kept constant. After the end of the feeds, the batch was stirred for a further 60 min at 85° C. and then cooled, and 1.6 g of Preventol® D2 were then added.

A polymer dispersion having a solids content of 28.2% and an extinction of 2.24 (measured at 660 nm on an aqueous sample diluted 1:10) was obtained.

### COMPARATIVE EXAMPLE 1

According to the Teaching of EP 051 144 A

The preparation was carried out analogously to Example 7.

Preparation of the 1^{st} st stage:

A mixture of 319.3 g of styrene, 80.7 g of N,N-dimethylaminopropyl-methacrylamide, 35.0 g of acrylic acid, 5.2 g of tert-dodecyl mercaptan (95%) and 350 g of glacial acetic acid was initially introduced at room temperature into a 2 l flask having a plane-ground joint and a stirrer and jacket heating and was heated to 95° C. under a nitrogen atmosphere and with stirring. After the reaction temperature had been reached, a solution of 6.4 g of azobisisobutyronitrile in 40.0 g of acetone was then metered uniformly into the reaction solution over a period of 120 min with continuing stirring. The batch was then stirred for a further 120 min at 95° C. and then cooled. A part of the batch was discharged, and 275.8 g remained in the apparatus for the preparation of the 2^{nd} stage. A clear polymer solution having a viscosity of 20 600 mPa.s was obtained.

Preparation of the 2^{nd} stage: 1,232 g of demineralized water were added at room temperature, while stirring, to the 275.8 g from the 1^{st} stage which remained in the apparatus. The mixture was heated to 85° C. under a nitrogen atmosphere and with continuing stirring. A homogeneous, turbid liquid phase was obtained. After the reaction temperature had been reached, the initially introduced mixture was stirred for a further 15 min and then 4.0 g of a 1% iron(II) sulfate solution were added. Thereafter, a mixture of 103.0 g of styrene, 60.4 g of n-butyl acrylate and 60.4 g of tert-butyl acrylate, and 78.3 g of a 3% hydrogen peroxide solution were metered simultaneously into the reaction mixture over 90 min at a constant rate from separate feeds, the temperature being kept constant. After the end of the feeds, the batch was stirred for a further 15 min at 85° C. and then 3.0 g of tert-butyl hydroperoxide (80%) were added for subsequent activation. After stirring had been carried out for a further 60 min at 85° C., the batch was cooled and 0.9 g of Preventol® D2 was added.

A polymer dispersion having a solids content of 20.2% and an extinction of 0.67 (measured at 660 nm on an aqueous sample diluted 1:10) was obtained.

### COMPARATIVE EXAMPLE 2

According to Teachings of EP 051 144 A

The preparation was effected analogously to Example 8.

Preparation of the 1^{st} stage, analogously to Example 1, EP 051 144 A

A mixture of 90.0 g of styrene, 49.5 g of N,N-dimethylamino-propylmethacrylamide, 22.5 g of acrylic acid, 90.0 g of glacial acetic acid and 1.5 g of azobisisobutyronitrile was initially introduced, at room temperature, into a 2 l flask having a plane-ground joint and a stirrer and jacket heating and was heated to 85° C. under a nitrogen atmosphere and with stirring. After the reaction temperature had been reached, stirring was carried out for a further 30 min and a solution of 1.9 g of azobisisobuty-ronitrile in 11.0 g of acetone was then metered uniformly into the reaction solution over a period of 60 min. The batch was then stirred for a further 30 min at 85° C. and then 875 g of demineralized water were added. For dissolution of the polymer, stirring was carried out for a further 55 min at 65-85° C., followed by cooling.

Preparation of the 2^{nd} stage:

The polymer solution from stage 1, heated to 85° C., was first stirred for 15 min and then 6.0 g of a 1% iron(II) sulfate solution and 30.0 9 of a 6% hydrogen peroxide solution were added in succession. Thereafter, a mixture of 99.0 g of styrene, 94.5 g of n-butyl acrylate and 94.5 g of tert-butyl acrylate, and 120 g of a 6% hydrogen peroxide solution, were metered into the reaction mixture simultaneously over 120 min at a constant rate from separate feeds, the temperature being kept constant. After the end of the feeds, the batch was stirred for a further 60 min at 85° C. and then cooled, and 1.6 g of Preventol® D2 were then added.

A polymer dispersion having a solids content of 29.1% and an extinction of 2.12 (measured at 660 nm on an aqueous sample diluted 1:10) was obtained.

### Use Examples

Sizing effect

The surface treatment of various test papers with the dispersions according to the invention and the comparative dispersions was effected using a laboratory size press from the firm Mathis, Zürich, Type HF. The size press liquor contained 5 parts by weight of an oxidized potato starch (Perfectamyl® A 4692) and 0.4-1.2 parts of the dispersions from Examples 1-8 and from Comparative examples 1-2, made up to 100 parts with water. The test papers were passed 1-3 times through the size press liquor in order in each case to achieve an adequate size pick-up. Here, size pick-up is to be understood as meaning the amount of size press liquor in per cent, based on the dry paper stock, which was absorbed by said paper stock, optionally after a plurality of passes through the size press.

The sizing effect of the dispersions according to the invention and of the comparative dispersions was tested on the following papers:

Paper a): unsized filler-containing coating base paper, basis weight 80 g/m², size pick-up 53% (Examples 1-4 and Example 6) or 68% (Example 5). Paper a) was passed once through the size press for treatment per liquor batch. The size pick-up is. based on this.

Paper b): unsized paper comprising 100% of mixed wastepaper, basis weight 120 g/m², size pick-up 60%. Paper b) was passed three times through the size press for treatment per liquor batch. The size pick-up is based on this.

Paper c): unsized testliner comprising 100% of mixed wastepaper, basis weight 115 g/m², size pick-up 45%. Paper c) was passed twice through the size press for treatment per liquor batch. The size pick-up is based on this.

Paper d): unsized lining board comprising 100% of mixed wastepaper, basis weight 190 g/m², size pick-up 29%. Paper d) was passed twice through the size press for treatment per liquor batch. The size pick-up is based on this.

The drying of the surface-sized papers was effected on a drying cylinder in the course of one minute at 90° C. The papers were then conditioned for 2 hours under standard climatic conditions (23° C., 50% relative humidity) before the degree of sizing was determined.

In order to assess the degree of sizing of the surface-sized papers, the Cobb₆₀ values were determined according to DIN 53122. The Cobb₆₀ value is defined as the water absorption of the paper sheet in g/m² after contact with water and after a contact time of 60 s. The lower this value, the better the degree of sizing of the respective paper.

The Cobb₆₀ values of the dispersions from Examples 1-6 are summarized in Table 1.

TABLE 1
Results of the sizing test, papers a) and b) with the dispersions according to the invention

| | | Example 1 | | Example 2 | | Example 3 | | Example 4 | | Example 5 | | Example 6 | |
|---|---|---|---|---|---|---|---|---|---|---|---|---|---|
| Solids | % | 19.7 | | 20.0 | | 19.8 | | 19.8 | | 19.8 | | 19.8 | |
| content | | | | | | | | | | | | | |
| Amount | % | 0.16 | 0.24 | 0.16 | 0.24 | 0.16 | 0.24 | 0.16 | 0.24 | 0.16 | 0.24 | 0.16 | 0.24 |
| used, | | | | | | | | | | | | | |
| solid | | | | | | | | | | | | | |
| Cobb test | | | | | | | | | | | | | |
| Paper a) | g/m² | 58 | 22.9 | 39 | 22.7 | 33 | 25.6 | 33 | 25.8 | 55 | 23.6 | 35 | 25.8 |
| Paper b) | g/m² | 33 | 23.0 | 24.4 | 21.7 | 26.9 | 24.4 | 26.9 | 23.3 | 22.6 | 20.3 | 42.0 | 24.7 |

The Cobb₆₀ values of the dispersions from Examples 7, 8 and Comparative examples 1, 2 are shown in Table 2.

TABLE 2
Results of the sizing test. Comparison of the dispersions according to the invention with
Comparative dispersions 1 and 2, papers c) and d)

| | | | | | Comparative | | | | | | Comparative | | |
|---|---|---|---|---|---|---|---|---|---|---|---|---|---|
| | | Example 7 | | | example 1 | | | Example 8 | | | example 2 | | |
| Solids | % | 20.0 | | | 20.2 | | | 28.2 | | | 29.1 | | |
| content | | | | | | | | | | | | | |
| Amount | % | 0.12 | 0.18 | 0.24 | 0.12 | 0.18 | 0.24 | 0.12 | 0.18 | 0.24 | 0.12 | 0.18 | 0.24 |
| used, | | | | | | | | | | | | | |
| solid | | | | | | | | | | | | | |
| Cobb test | | | | | | | | | | | | | |
| Paper c) | g/m² | 31 | 20 | — | 49 | 23.5 | — | 26.7 | 18.7 | — | 29.3 | 19.0 | — |
| Paper d) | g/m² | — | 30 | 21 | — | 59 | 25.1 | — | 25.6 | 20.8 | — | 59 | 22.1 |

The dispersion of Comparative example 1 shows poorer sizing properties compared with Example 7, as does the dispersion of Comparative example 2 compared with Example 8.

Tendency to Foam

The tendency to foam formation was determined as follows: 250 ml each of a size press liquor from Example 5 and Comparative example 2 were introduced into a cylinder (height: 42 cm, diameter: 6 cm). The size press liquors contained in each case 5% by weight of Perfectamyl® A4692 and 1% by weight of polymer dispersion according to Example 5 and Comparative example 2, respectively. Foam was produced by means of a small propeller (1 000 rpm) and by passing in air (400 ml/min). After 2 minutes, the air supply was stopped and the stirrer was switched off. The resulting amount of foam was read:

Example 5: Amount of foam 110 ml; Comparative example 2: Amount of foam 140 ml.

Thus, the size liquor prepared using the dispersions according to the invention exhibits an amount of foam which is 21.5% lower than the size liquor prepared using the dispersion of the prior art.

Although the present invention has been described in detail with reference to certain preferred versions thereof, other variations are possible. Therefore, the spirit and scope of the appended claims should not be limited to the description of the versions contained therein.

Although the invention has been described in detail in the foregoing for the purpose of illustration, it is to be understood that such detail is solely for the purpose and that variations can be made therein by those skilled in the art without departing from the spirit and scope of the invention except as it may be limited by the claims.

What is claimed is:

1. A cationic aqueous polymer dispersion comprising small particles comprising an emulsion polymerization product of:
(1) a monomer mixture comprising
a) from about 20 to about 60% by weight of at least one optionally substituted styrene,
b) from about 40 to about 80% by weight of at least one C₁-C₁₈-(meth)acrylic acid ester and
c) from 0 to about 20% by weight of at least one non-ionic ethylenically unsaturated monomer differing from a) and b), the sum of a)+b)+c) being 100% by weight, wherein the monomer mixture is polymerized in the presence of
(2) an emulsifier comprising a solution polymerization product of a monomer mixture comprising
d) from about 15 to about 35% by weight of at least one (meth)acrylic acid ester and/or (meth)acrylamide which contains a tertiary amino group,
e) from about 65 to about 85% by weight of at least one optionally substituted styrene and
f) from 0 to about 20% by weight of at least one non-ionic or cationic ethylenically unsaturated monomer differing from d) and e), the sum of d)+e)+f) being 100% by weight, wherein the solution polymerization is carried out in the presence of a saturated C₁ -C₆-carboxylic acid.

2. The cationic aqueous polymer dispersion according to claim 1, wherein the C₁-C₆-carboxylic acid is a mono-carboxylic acid.

3. The cationic aqueous polymer dispersion according to claim 1, wherein the C₁-C₆-carboxylic acid is acetic acid.

4. The cationic aqueous polymer dispersion according to claim 3, wherein the acetic acid contains not more than about 20% by weight of water.

5. The cationic aqueous polymer dispersion according to claim 1, wherein the emulsifier is present as an aqueous polymer dispersion with 2-20% solids by weight.

6. The cationic aqueous polymer dispersion according to claim 1, wherein the monomers a) and e) are styrene.

7. The cationic aqueous polymer dispersion according to claim 1, wherein from about 30 to about 50% by weight of styrene are used as monomer a) and from about 70 to about 80% by weight of styrene are used as monomer e).

8. The cationic aqueous polymer dispersion according to claim 1, wherein monomers of the formula (I) 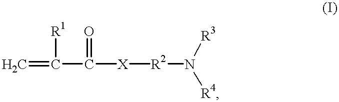
in which
R¹ represents H or methyl,
R² represents a linear C₁-C₄-alkylene radical,
R³ and R⁴ are identical or different and represent C₁-C₄-alkyl and
X represents O or NH,
are used as monomers of the group d).

9. The cationic aqueous polymer dispersion according to claim 8, wherein from about 20 to about 30% by weight of the compounds of the formula (I) according to claim 8 are used as monomer d).

10. The cationic aqueous polymer dispersion according to claim 1, wherein at least one compound from the series methyl acrylate, methyl methacrylate, ethyl acrylate, ethyl methacrylate, propyl acrylate, propyl methacrylate, n-butyl acrylate, iso-butyl acrylate, tert-butyl acrylate, n-butyl methacrylate, iso-butyl methacrylate, tert-butyl methacrylate, hexyl acrylate, hexyl methacrylate, ethylhexyl acrylate, stearyl acrylate and stearyl methacrylate is used as monomer b).

11. A process for making a cationic aqueous polymer dispersion comprising:
(1) preparing a polymer dispersion by solution polymerization of a monomer mixture comprising:
d) from about 15 to about 35% by weight of at least one (meth)acrylic acid ester and/or (meth)acrylamide which contains a tertiary amino group,
e) from about 65 to about 85% by weight of at least one optionally substituted styrene and
f) from 0 to about 20% by weight of at least one non-ionic or cationic ethylenically unsaturated monomer differing from d) and e), the sum of d)+e)+f) being 100% by weight, in at least one saturated C₁-C₆-carboxylic acid, subsequent addition of water for the preparation of an aqueous polymer dispersion and
(2) emulsion polymerization of a monomer mixture comprising
a) 20 to 60% by weight of at least one optionally substituted styrene,
b) 40 to 80% by weight of at least one C₁-C₁₈-(meth)acrylic acid ester and
c) 0 to 20% by weight of at least one non-ionic ethylenically unsaturated monomer differing from a) and b), the sum of a)+b)+c) being 100% by weight, in the presence of said aqueous polymer dispersion.

12. The process according to claim 11, wherein, after the end of the emulsion polymerization, an oil-soluble free radical initiator sparingly soluble in water is added for subsequent activation.

13. A process for making a cationic aqueous polymer dispersion comprising the emulsion polymerization of
(1) a monomer mixture comprising
a) from about 20 to about 60% by weight of at least one optionally substituted styrene,
b) from about 40 to about 80% by weight of at least one. C₁-C₁₈-(meth)acrylic acid ester and
c) from 0 to about 20% by weight of at least one non-ionic ethylenically unsaturated monomer differing from a) and b), the sum of a)+b)+c) being 100% by weight, and
(2) an aqueous polymer dispersion comprising a solution polymerization product of monomer mixture comprising
d) from about 15 to about 35% by weight of at least one (meth)acrylic acid ester and/or (meth)acrylamide which contains a tertiary amino group,
e) from about 65 to about 85% by weight of at least one optionally substituted styrene and
f) from 0 to about 20% by weight of at least one non-ionic or cationic ethylenically unsaturated monomer differing from d) and e), the sum of d)+e)+f) being 100% by weight, wherein the solution polymerization is carried out in saturated C₁-C₆-carboxylic acid.

14. The process of claim 13, wherein the C₁-C₆-carboxylic acid is a monocarboxylic acid.

15. The process of claim 13, wherein the C₁-C₆-carboxylic acid is acetic acid.

16. The process of claim 13, wherein the acetic acid contains not more than about 20% by weight of water.

17. The process of claim 13, wherein the aqueous polymer dispersion contains 2-20% solids by weight.

18. The process of claim 13, wherein the monomers a) and e) are styrene.

19. The process of claim 13, wherein from about 30 to about 50% by weight of styrene are used as monomer a) and from about 70 to about 80% by weight of styrene are used as monomer e).

20. The process of claim 13, wherein monomers of the group d) are monomers of the formula (I) 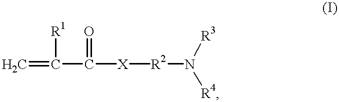
in which
R¹ represents H or methyl,
R² represents a linear C₁-C₄-alkylene radical,
R³ and R⁴ are identical or different and represent C₁-C₄-alkyl and
X represents O or NH.

20. The process of claim 19, wherein from about 20 to about 30% by weight of the compounds of the formula (I) according to claim 19 are used as monomer d).

21. The process of claim 13, wherein monomer b) is selected from the group consisting of methyl acrylate, methyl methacrylate, ethyl acrylate, ethyl methacrylate, propyl acrylate, propyl methacrylate, n-butyl acrylate, iso-butyl acrylate, tert-butyl acrylate, n-butyl methacrylate, iso-butyl methacrylate, tert-butyl methacrylate, hexyl acrylate, hexyl methacrylate, ethylhexyl acrylate, stearyl acrylate, stearyl methacrylate, and mixtures thereof.
